(19) United States
(12) Patent Application Publication
(10) Pub. No.: US 2019/0202010 A1
(43) Pub. Date: Jul. 4, 2019

(54) CAR BODY POSITIONING JIG DEVICE

(71) Applicant: HONDA MOTOR CO., LTD., MINATO-KU, TOKKYO (JP)

(72) Inventors: Kazuki AKAMI, HAGAGUN, TOCHIGI (JP); Akinori HASADO, HAGAGUN, TOCHIGI (JP); Koichi TAKEUCHI, HAGAGUN, TOCHIGI (JP); Hirotaka KITAGAWA, HAGAGUN, TOCHIGI (JP); Hiroshi ICHINOMIYA, HAGAGUN, TOCHIGI (JP); Masao SHIMOYAMA, HAGAGUN, TOCHIGI (JP); Kazuhisa HADA, HAGAGUN, TOCHIGI (JP)

(21) Appl. No.: 16/333,019

(22) PCT Filed: Sep. 14, 2017
(86) PCT No.: PCT/JP2017/033284

§ 371 Date: Mar. 13, 2019

(30) Foreign Application Priority Data
Sep. 14, 2016 (JP) 2016-179931

(51) Int. Cl. B23K 37/04; B23P 21/00; B62D 65/02

(52) U.S. Cl. CPC B23K 37/04; B23K 2101/006; B62D 65/026; B23P 21/002

(57) ABSTRACT

The present invention provides a car body positioning jig device capable of limiting the restriction of movement of a welding device, etc. In the car body positioning jig device, at least a portion of a main body section is disposed closer to an internal space of a body assembly than an opening. The main body section comprises: a first positioning mechanism unit for adjustably supporting the position of a first positioning member that positions a first region of the opening; a second positioning mechanism unit for adjustably supporting the position of a second positioning member that positions a second region of the opening; and a frame part for supporting the first positioning mechanism unit and the second positioning mechanism unit.

### TECHNICAL FIELD

The present invention relates to a car body positioning jig device.

### BACKGROUND ART

Conventionally, a plurality of body panels are joined to each other through welding, and thereby a body of an automobile, and the like is integrally formed. Here, in a case where the plurality of body panels are joined to each other through welding, the plurality of body panels need to be positioned such that positions of the body panels are not displaced during a welding operation. In particular, a positional relationship between the panels is demanded to be highly accurate in vicinity of an opening of a body.

In this respect, a device that causes a positioning jig device to position the plurality of body panels in the vicinity of the opening of the body and performs spot welding (for example, refer to Patent Document 1).

Patent Document 1: Japanese Patent No. 2974262

### DISCLOSURE OF THE INVENTION

### Problems to be Solved by the Invention

Here, in the device disclosed in Patent Document 1, when spot welding is performed in the vicinity of the body opening, it is necessary to consider avoidance of interference of the positioning jig device with movement of a spot welding gun.

On the other hand, the positioning jig device needs to be used for a plurality of types of bodies and, thus, needs to include various position adjustment mechanisms, and the like. Therefore, the positioning jig device tends to be large in size. That is, a range in which the spot welding gun can freely move tends to be limited.

In such a circumstance, even in a case where the positioning jig device includes the position adjustment mechanism, and the like, it is desired to develop a car body positioning jig device that is capable of least suppressing a range, in which it is possible to perform a welding operation of the spot welding gun. In other words, it is desired to develop the car body positioning jig device that is to least restrict movement of a welding device, and the like.

An object of the invention is to provide a car body positioning jig device capable of limiting the restriction of movement of a welding device, and the like.

### Means for Solving the Problems

According the invention, there is provided a car body positioning jig device (for example, a car body positioning jig device 1 to be described below) including: a first positioning member (for example, a first positioning member 50 to be described below) that positions a first region (for example, a first region P1 to be described below) of an opening (for example, an opening K to be described below) in a body assembly (for example, a body assembly W to be described below); a second positioning member (for example, a second positioning member 60 to be described below) that positions a second region (for example, a second region P2 to be described below) of the opening in the body assembly, a main body section (for example, a main body section 10 to be described below); and an articulated robot section (for example, an articulated robot section 80) by which the main body section is movably supported and which is capable of disposing at least a portion of the main body section closer to an inside (for example, an internal space N to be described below) of the body assembly than the opening. The main body section includes a first positioning mechanism unit (for example, a first positioning mechanism unit 30 to be described below) for adjustably supporting a position of the first positioning member, a second positioning mechanism unit (for example, a second positioning mechanism unit 40 to be described below) for adjustably supporting a position of the second positioning member, and a frame part (for example, a frame part 20 to be described below) for supporting the first positioning mechanism unit and the second positioning mechanism unit. The first positioning member includes a first arm part (for example, a first arm part 54 to be described below) that is attached to the first positioning mechanism unit and is disposed to be extended to an outer edge side of the opening, and a first holding part (for example, a first holding part 56 to be described below) that is disposed on a distal end side of the first arm part and positions the first region in the opening. The second positioning member includes a second arm part (for example, a second arm part 64 to be described below) that is attached to the second positioning mechanism unit and is disposed to be extended to an outer edge side of the opening, and a second holding part (for example, a second holding part 66 to be described below) that is disposed on a distal end side of the second arm part and positions the second region in the opening.

Consequently, the car body positioning jig device according to the invention includes the first positioning mechanism unit, the second positioning mechanism unit, and the frame part for supporting the first and second positioning mechanism units, and thereby at least a portion of the main body section that occupies the largest volume can be disposed on the inside than the opening. Therefore, the main body section can be disposed at a position separated from a movement range of a welding gun, and the like, and thus it is possible to limit the restriction of movement of the welding gun, and the like. In addition, in the car body positioning jig device according to the invention, the main body section can be disposed at any position, and the first region and the second region can be set at any positions in the opening. Consequently, the car body positioning jig device according to the invention can further limit the restriction of the movement of a welding device, and the like, and thus it is possible to come into a state in which a welding operation is easily performed. In addition, in the car body positioning jig device according to the invention, the main body section can be disposed at any position, and the first region and the second region can be set at any positions in the opening. Therefore, the car body positioning jig device can be suitably used for each of different types (car models) of body assemblies.

In addition, in the car body positioning jig device of the invention, it is preferable that the first holding part and the second holding part be disposed at positions on both right and left sides with respect to the frame part.

Consequently, in the car body positioning jig device according to the invention, the first holding part and the second holding part are disposed at the positions on both the right and left sides with respect to the frame part, and thereby the car body positioning jig device has a configuration in which loads applied to the first holding part and the second holding part, respectively, are easily balanced. Therefore, in the car body positioning jig device according to the invention, it is possible to limit a load that is applied to the articulated robot section, and thus it is possible to reduce the articulated robot section in size.

In addition, in the car body positioning jig device of the invention, it is preferable that the car body positioning jig device correct a position by a visual sensor, and a marker for the visual sensor be attached to an upper side of the frame part.

Consequently, since the marker is disposed on the upper side of the frame part, measurement of an absolute position of the main body section by the visual sensor is not hindered by configurational members of the main body section, the articulated robot section itself, or shadows thereof, and thus it is possible to improve accuracy of positional measurement. In addition, consequently, in the car body positioning jig device according to the invention, a degree of freedom for disposition of the visual sensor improves.

In addition, in the car body positioning jig device of the invention, it is preferable that the first positioning mechanism unit include a first right-left direction positioning mechanism unit (for example, a first right-left rail 32 to be described below and a first right-left drive unit) that adjusts a position of the first positioning member in a right-left direction, the second positioning mechanism unit include a second right-left direction positioning mechanism unit (for example, a second right-left rail 42 to be described below and a second right-left drive unit) that adjusts a position of the second positioning member in the right-left direction, and the first right-left direction positioning mechanism unit and the second right-left direction positioning mechanism unit be disposed to be completely accommodated on the more inside of the body assembly than the opening in a side view.

Consequently, in the car body positioning jig device according to the invention, the first right-left direction positioning mechanism unit and the second right-left direction positioning mechanism unit are disposed to be completely accommodated on the more inside of the body assembly than the opening in a side view. Therefore, the main body section can be disposed at a position further separated from the movement range of the welding gun, and the like, and thus it is possible to further limit the restriction of movement of the welding gun, and the like.

### Effects of the Invention

According to the invention, it is possible to provide a car body positioning jig device capable of limiting the restriction of movement of a welding device, and the like.

### BRIEF DESCRIPTION OF THE DRAWINGS

FIG. 1 is a perspective view of a car body positioning jig device in a state in which an opening of a body assembly is welded.

FIG. 2 is a plan view describing a configuration of the car body positioning jig device.

FIG. 3 is a left side view describing the configuration of the car body positioning jig device.

FIG. 4 is a rear side view describing the configuration of the car body positioning jig device.

FIG. 5 is a plan view describing states of the car body positioning jig device and a welding gun during welding.

FIG. 6 is a plan view describing a state in which a portion of a main body section of the car body positioning jig device is disposed closer to an internal space than the opening at a time of a welding operation.

FIG. 7 is a plan view describing a state in which the car body positioning jig device positions the opening of the body assembly at the time of the welding operation.

FIG. 8 is a plan view describing a state in which welding is performed by the welding gun in a state in which the car body positioning jig device positions the opening at the time of the welding operation.

### PREFERRED MODE FOR CARRYING OUT THE INVENTION

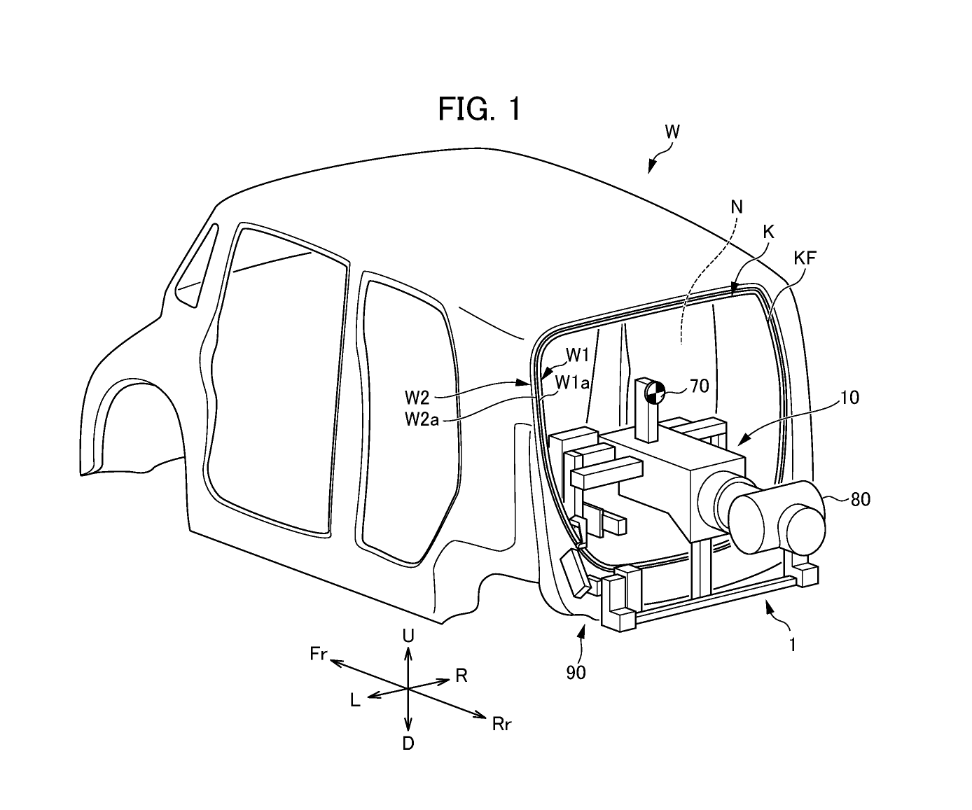

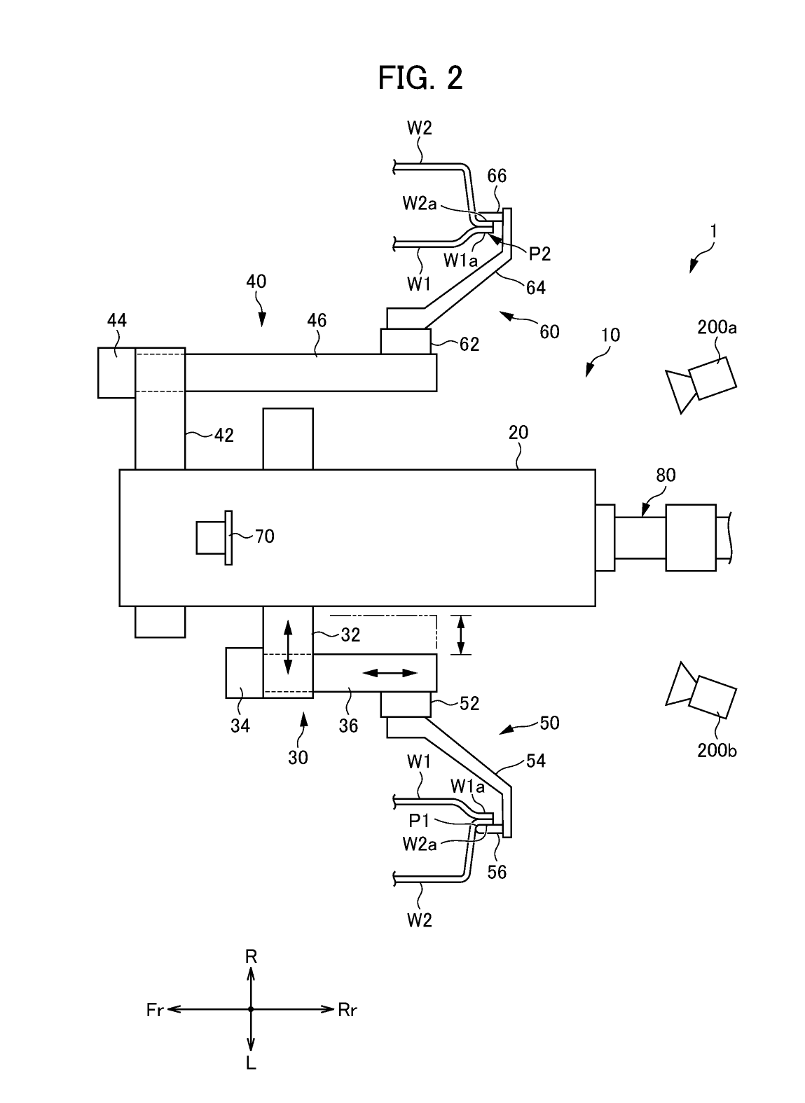

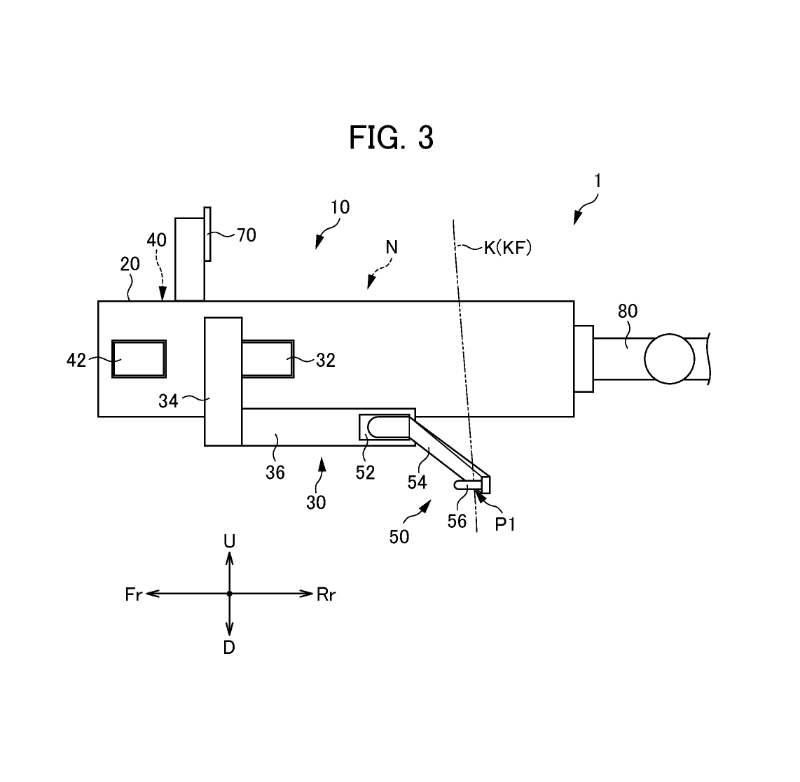

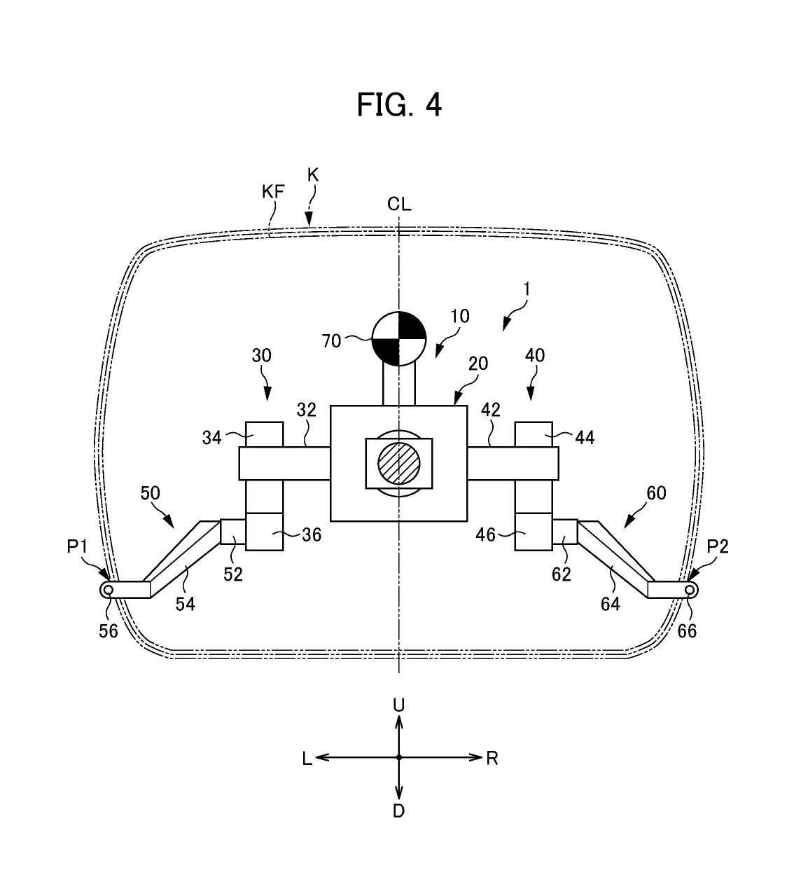

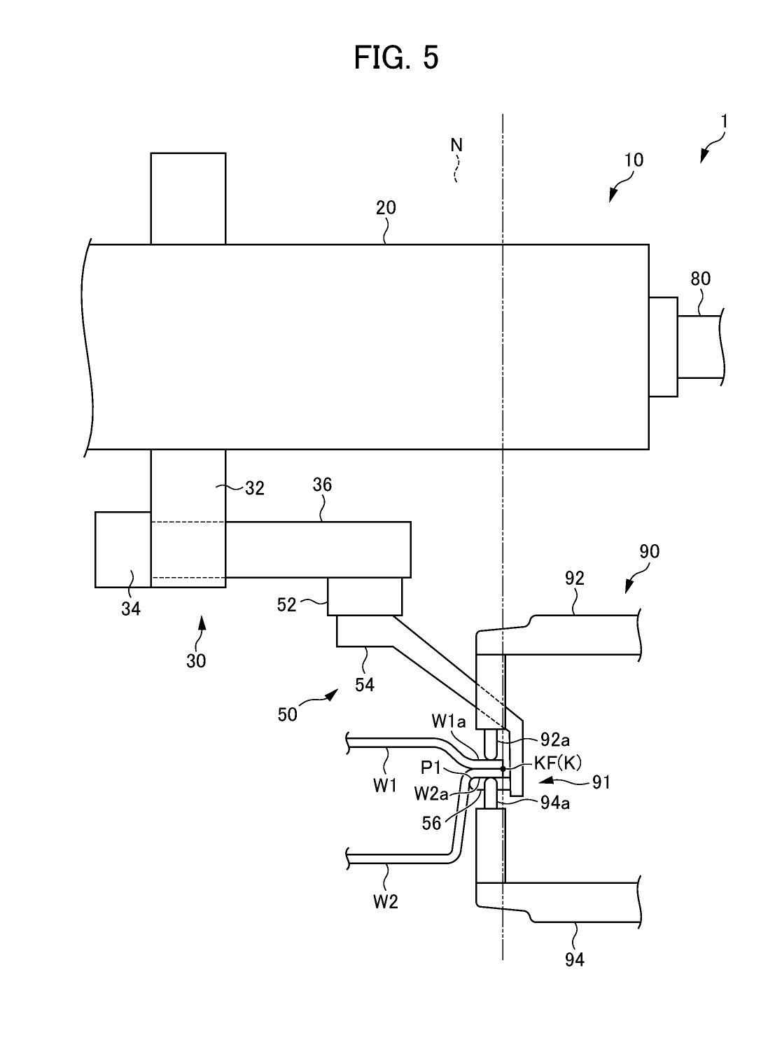

Hereinafter, an embodiment of the invention will be described in detail with reference to the drawings. First, a car body positioning jig device 1 in the embodiment will be described with reference to FIGS. 1 to 5. FIG. 1 is a perspective view of the car body positioning jig device in a state in which an opening of a body assembly is welded. FIG. 2 is a plan view describing a configuration of the car body positioning jig device. FIG. 3 is a left side view describing the configuration of the car body positioning jig device. FIG. 4 is a rear side view describing the configuration of the car body positioning jig device. FIG. 5 is a plan view describing states of the car body positioning jig device and a welding gun during welding. Incidentally, in the drawings, an Fr direction represents a front direction, an Rr direction represents a rear direction, an R direction represents a right direction, an L direction represents a left direction, a U direction represents an upward direction, and a D direction represents a downward direction.

As illustrated in FIG. 1, a body assembly W includes an opening K, an opening distal end portion KF which is a distal end portion of flanges W1a and W2a in the opening K, and an internal space N. In the embodiment, the opening K is an opening of a so-called rear hatch. The body assembly W may be a body assembly of any vehicle type and is, preferably, a body assembly of a hatchback type vehicle.

The body assembly W is configured to have an inner panel W1 disposed on a side of the internal space N and an outer panel W2 disposed on a side of an external space. The inner panel W1 and the outer panel W2 are welded to each other in the vicinity of the opening K. Specifically, the flange W1a on a side of the inner panel W1 and the flange W2a on a side of the outer panel W2 in the opening K are welded by a welding device 90 (welding gun 91) to be described below. More specifically, the flange W1a on a side of the inner panel W1 and the flange W2a on a side of the outer panel W2 in the opening K are welded by the welding device 90 (welding gun 91) in a state in which the car body positioning jig device 1 positions the flanges (hereinafter, simply referred to as “the opening is welded” in some cases).

As illustrated in FIG. 1, the car body positioning jig device 1 includes a main body section 10, a first positioning member 50, a second positioning member 60, and an articulated robot section 80. In the car body positioning jig device 1, in a state in which at least a portion of the main body section 10 is disposed closer to the internal space N of the body assembly W than the opening K, the flanges W1a and W2a in the opening K are positioned. To be detailed, in the car body positioning jig device 1, in a state in which at least a portion of the main body section 10 is disposed closer to the internal space N than a surface formed on the opening distal end portion KF, the flanges W1a and W2a in the opening K are positioned.

In the car body positioning jig device 1, the main body section 10 is caused to approach the opening K from a rear side (one side in a front-rear direction) of the body assembly W, and a first positioning mechanism unit 30 and a second positioning mechanism unit 40 to be described below cause the first positioning member 50 and the second positioning member 60 to move. In this manner, a first region P1 and a second region P2 to be described below in the opening K (flanges W1a and W2a) are positioned.

Subsequently, the configuration of the car body positioning jig device 1 will be described in detail with reference to FIGS. 2 to 5. First, as described above, the car body positioning jig device 1 includes the main body section 10, the first positioning member 50, the second positioning member 60, and the articulated robot section 80 by which the main body section 10 can be movably supported and which is capable of disposing at least a portion of the main body section 10 closer to the internal space (inside) of the body assembly W than the opening K in the body assembly W. Here, the articulated robot section 80 is configured to be three-dimensionally changeable in a position and a posture of the main body section 10. The articulated robot section 80 adjusts the position and the posture of the main body section 10 by a control unit not illustrated. The articulated robot section 80 is attached to the ground.

The main body section 10 includes a frame part 20, the first positioning mechanism unit 30, the second positioning mechanism unit 40, a marker 70, and a control unit not illustrated. In addition, the car body positioning jig device 1 includes visual sensors 200a and 200b.

The frame part 20 supports the first positioning mechanism unit 30 and the second positioning mechanism unit 40. In the embodiment, the frame part 20 directly holds a first right-left rail 32 to be described below in the first positioning mechanism unit 30 and a second right-left rail 42 to be described below in the second positioning mechanism unit 40.

In addition, the frame part 20 is disposed at the center of the main body section 10 in a right-left direction. In other words, the frame part 20 holds the first positioning mechanism unit 30 and the second positioning mechanism unit 40 such that the first positioning mechanism unit 30 and the second positioning mechanism unit 40 are bilaterally symmetrical with a center line CL as the center in the right-left direction in a rear view (refer to FIG. 4). In addition, the frame part 20 holds the first positioning member 50 and the second positioning member 60 such that the first positioning member 50 and the second positioning member 60 are bilaterally symmetrical with the center line CL as the center in the right-left direction in a rear view (refer to FIG. 4).

The first positioning mechanism unit 30 is a mechanism unit for adjustably supporting the position of the first positioning member 50. As described above, the frame part 20 holds the first positioning mechanism unit 30. The first positioning mechanism unit 30 is disposed on an opposite side of the second positioning mechanism unit 40 excluding the first right-left rail 32 in the right-left direction.

The first positioning mechanism unit 30 includes the first right-left rail 32, a first up-down rail 34, a first front-rear rail 36, a first right-left drive unit (not illustrated) that causes the first right-left rail 32 to slidably move in the right-left direction, a first up-down drive unit (not illustrated) that causes the first up-down rail 34 to slidably move in an up-down direction, and a first front-rear drive unit that causes the first front-rear rail 36 to slidably move in the front-rear direction. Here, the drive units is each configured to have a drive source such as a motor and a transmission mechanism unit such as a ball screw mechanism or a belt mechanism that transmits a drive force from the drive source to each of the rails.

The first right-left rail 32 is a rail member that is disposed to be extended in the right-left direction. The first right-left rail 32 is held by the frame part 20 so as to be slidably movable in the right-left direction. The first right-left rail 32 is caused to slidably move in the right-left direction by the first right-left drive unit. In addition, the first right-left rail 32 holds the first up-down rail 34 such that the first up-down rail 34 is slidably movable in the up-down direction.

The first up-down rail 34 is a rail member that is disposed to be extended in the up-down direction. The first up-down rail 34 is held by the first right-left rail 32 so as to be slidably movable in the up-down direction. The first up-down rail 34 is caused to slidably move in the up-down direction by the first up-down drive unit. In addition, the first up-down rail 34 holds the first front-rear rail 36 such that the first front-rear rail 36 is slidably movable in the front-rear direction.

The first front-rear rail 36 is a rail member that is disposed to be extended in the front-rear direction. The first front-rear rail 36 is held by the first up-down rail 34 so as to be slidably movable in the front-rear direction. The first front-rear rail 36 is caused to slidably move in the front-rear direction by the first front-rear drive unit. In addition, the first front-rear rail 36 holds the first positioning member 50.

As described above, the first positioning mechanism unit 30 combines movement by the first right-left rail 32 in the right-left direction, movement by the first up-down rail 34 in the up-down direction, and movement by the first front-rear rail 36 in the front-rear direction so as to cause the first positioning member 50 to move forward, rearward, rightward, leftward, upward, and downward and position in the first region P1. Consequently, in the car body positioning jig device 1, the main body section 10 can be disposed at any position, and the first region P1 can be set at any position in the opening K.

Here, in the embodiment, the first right-left rail 32, the first up-down rail 34, and the first front-rear rail 36 are disposed to be completely accommodated closer to the internal space N than the opening K (opening distal end portion KF) in a side view as illustrated in FIG. 3. When a moving route of the welding gun 91 to be described below is considered, it is particularly important that the first right-left rail 32 is completely disposed closer to the internal space N than the opening K (opening distal end portion KF) in a side view.

Subsequently, the second positioning mechanism unit 40 is a mechanism unit for adjustably supporting the position of the second positioning member 60. In addition, as described above, the frame part 20 holds the second positioning mechanism unit 40. The second positioning mechanism unit 40 is disposed on an opposite side of the first positioning mechanism unit 30 excluding the second right-left rail 42 to be described below in the right-left direction.

The second positioning mechanism unit 40 includes the second right-left rail 42, a second up-down rail 44, a second front-rear rail 46, a second right-left drive unit (not illustrated) that causes the second right-left rail to slidably move in the right-left direction, a second up-down drive unit (not illustrated) that causes the second up-down rail 44 to slidably move in the up-down direction, and a second front-rear drive unit that causes the second front-rear rail 46 to slidably move in the front-rear direction. Here, the drive units are each configured to have a drive source such as a motor and a transmission mechanism unit such as a ball screw mechanism or a belt mechanism that transmits a drive force from the drive source to each of the rails.

The second right-left rail 42 is a rail member that is disposed to be extended in the right-left direction. The second right-left rail 42 is held by the frame part 20 so as to be slidably movable in the right-left direction. The second right-left rail 42 is caused to slidably move in the right-left direction by the second right-left drive unit. In addition, the second right-left rail 42 holds the second up-down rail 44 such that the second up-down rail 44 is slidably movable in the up-down direction.

The second up-down rail 44 is a rail member that is disposed to be extended in the up-down direction. The second up-down rail 44 is held by the second right-left rail 42 so as to be slidably movable in the up-down direction. The second up-down rail 44 is caused to slidably move in the up-down direction by the second up-down drive unit. In addition, the second up-down rail 44 holds the second front-rear rail 46 such that the second front-rear rail 46 is slidably movable in the front-rear direction.

The second front-rear rail 46 is a rail member that is disposed to be extended in the front-rear direction. The second front-rear rail 46 is held by the second up-down rail 44 so as to be slidably movable in the front-rear direction. The second front-rear rail 46 is caused to slidably move in the front-rear direction by the second front-rear drive unit. In addition, the second front-rear rail 46 holds the second positioning member 60.

As described above, the second positioning mechanism unit 40 combines movement by the second right-left rail 42 in the right-left direction, movement by the second up-down rail 44 in the up-down direction, and movement by the second front-rear rail 46 in the front-rear direction so as to cause the second positioning member 60 to move forward, rearward, rightward, leftward, upward, and downward and position in the second region P2. Consequently, in the car body positioning jig device 1, the main body section 10 can be disposed at any position, and the second region P2 can be set at any position in the opening K.

Here, in the embodiment, similarly to the first positioning mechanism unit 30, the second right-left rail 42, the second up-down rail 44, and the second front-rear rail 46 are completely disposed closer to the internal space N than the opening K (opening distal end portion KF) in a side view. When the moving route of the welding gun 91 to be described below is considered, it is particularly important that the second right-left rail 42 is completely disposed closer to the internal space N than the opening K (opening distal end portion KF) in a side view.

As clarified from the description provided above, the main body section 10 is configured to have the frame part 20, the first right-left rail 32, the first up-down rail 34, and the first front-rear rail 36 which configure the first positioning mechanism unit 30, the second right-left rail 42, the second up-down rail 44, and the second front-rear rail 46 which configure the second positioning mechanism unit 40.

Subsequently, the first positioning member 50 is a positioning member that positions the first region P1 of the opening K (opening distal end portion KF). The first positioning member 50 includes a first proximal end portion 52, a first arm part 54, and a first holding part 56. As described above, the first positioning member 50 is movably held by the first positioning mechanism unit 30 (first front-rear rail 36).

The first proximal end portion 52 is disposed on a side of one end portion in the first arm part 54. The first proximal end portion 52 is a portion that is attached to the first positioning mechanism unit 30 (first front-rear rail 36).

The first arm part 54 is a member that is disposed to be extended from the first proximal end portion 52 toward an outer edge side of the opening K. The first arm part 54 is extended to an outer side (for example, a lower side in FIG. 2) in the right-left direction and is disposed to be extended toward a rear side (for example, a right side in FIG. 2) in the front-rear direction. In the embodiment, the first arm part 54 is formed to have a hook shape on end portion side opposite to the side of the first proximal end portion 52. In addition, the first holding part 56 is disposed on an end portion of the first arm part 54 on the outer edge side of the opening K.

The first holding part 56 is disposed on a distal end side (end portion on an opposite side of the first proximal end portion 52) of the first arm part 54. The first holding part 56 is a holding part that positions the first region P1 in the opening K (opening distal end portion KF). In the embodiment, the first holding part 56 abuts the flange W2a of the outer panel W2 so as to position the outer panel W2.

Similarly to the first positioning member 50 described above, the second positioning member 60 is a positioning member that positions the second region P2 of the opening K (opening distal end portion KF). The second positioning member 60 includes a second proximal end portion 62, a second arm part 64, and a second holding part 66. As described above, the second positioning member 60 is movably held by the second positioning mechanism unit 40 (second front-rear rail 46).

The second proximal end portion 62 is disposed on a side of one end portion in the second arm part 64. The second proximal end portion 62 is a portion that is attached to the second positioning mechanism unit 40 (second front-rear rail 46).

The second arm part 64 is a member that is disposed to be extended from the second proximal end portion 62 toward the outer edge side of the opening K. The second arm part 64 is extended to an outer side (for example, an upper side in FIG. 2) in the right-left direction and is disposed to be extended toward a rear side (for example, a right side in FIG. 2) in the front-rear direction. In the embodiment, the second arm part 64 is formed to have a hook shape on one end portion side opposite to the side of the second proximal end portion 62. In addition, the second holding part 66 is disposed on an end portion of the second arm part 64 on the outer edge side of the opening K.

The second holding part 66 is disposed on a distal end side (end portion on an opposite side of the second proximal end portion 62) of the second arm part 64. The second holding part 66 is a holding part that positions the second region P2 in the opening K (opening distal end portion KF). In the embodiment, the second holding part 66 abuts the flange W2a of the outer panel W2 so as to position the outer panel W2.

Here, the first holding part 56 and the second holding part 66 are disposed at bilaterally symmetrical positions with respect to the frame part 20. The first positioning member 50 and the second positioning member 60 are disposed at bilaterally symmetrical positions with the center line CL as the center in the right-left direction in the rear view (refer to FIG. 4).

Incidentally, in the embodiment, the first positioning member and the second positioning member (specifically, the first arm part 54 and the second arm part 64) are extended from the main body section 10 toward the rear side, and thereby the first holding part 56 and the second holding part 66 are positioned on the outer side of the car body.

The marker 70 is disposed on an upper side of the main body section 10. The marker 70 is a marker for the visual sensors 200a and 200b. The marker 70 is disposed at a position at which recognition of the marker by the visual sensors 200a and 200b is not hindered by configurational members of the main body section 10, the articulated robot section 80 itself, or shadows thereof.

In the embodiment, the visual sensors 200a and 200b are disposed on the upper side of the rear side (for example, a right side in FIG. 2) of the main body section 10. The visual sensors 200a and 200b recognize a position of the marker 70 described above continuously or at predetermined intervals. For example, the visual sensors 200a and 200b are used to monitor whether or not the positions at which the visual sensors need to be disposed on the main body section 10 are displaced. The visual sensors 200a and 200b output positional information of the marker 70 to a control unit (not illustrated). Then, the control unit controls (adjusts) motion of the articulated robot section 80 as necessary based on the positional information.

In addition, the flange W1a on the side of the inner panel W1 and the flange W2a on the side of the outer panel W2 in the opening K are welded by the welding device 90 (welding gun 91) in a state in which the car body positioning jig device 1 positions the flanges to each other. As illustrated in FIG. 5, the welding device 90 is configured to include the welding gun 91 and an articulated robot section (not illustrated) by which the welding gun 91 is movably supported.

The welding gun 91 includes gun arms 92 and 94 and electrode chips 92a and 94a. The welding gun 91 welds the flange W1a on the side of the inner panel W1 and the flange W2a on the side of the outer panel W2 in a state in which the car body positioning jig device 1 positions the flanges to each other. In the embodiment, the welding gun 91 is an X-type gun; however, the welding gun is not limited thereto, and the welding gun may be a C-type gun. In addition, the welding gun is not limited to the welding, and the welding gun may be another bonding device for joining or the like or a measurement device, instead of the joining.

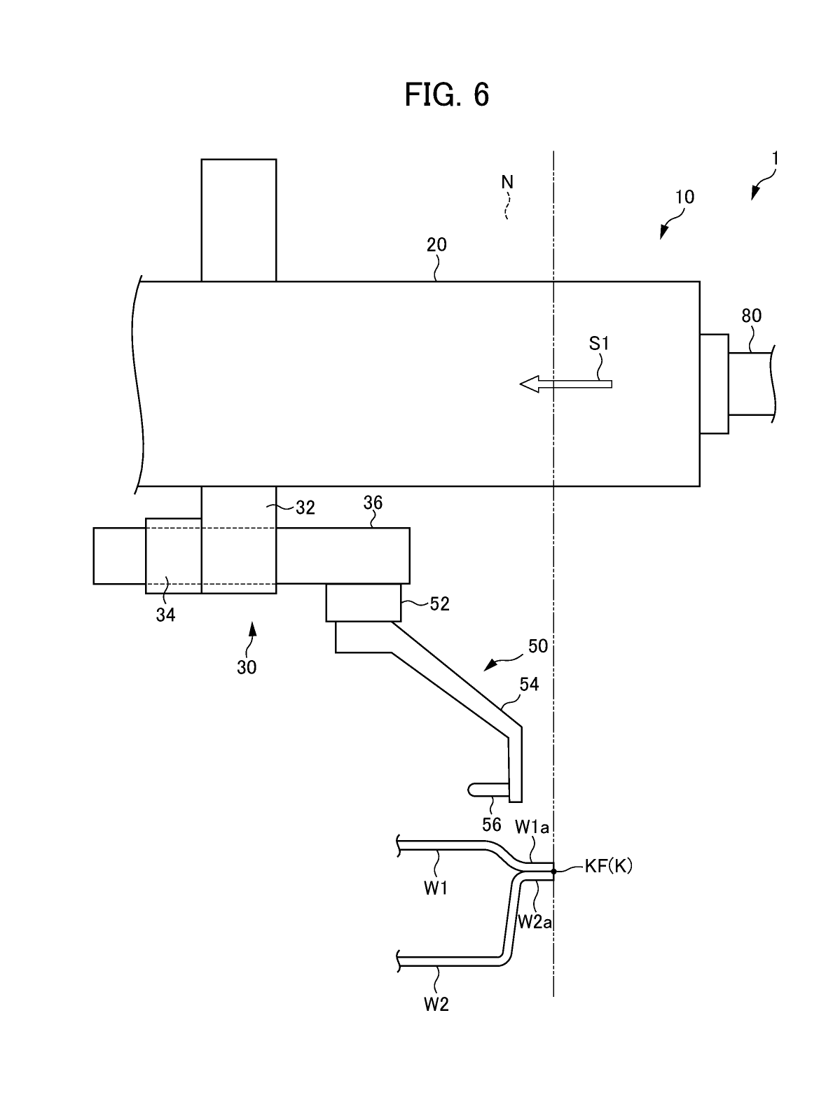

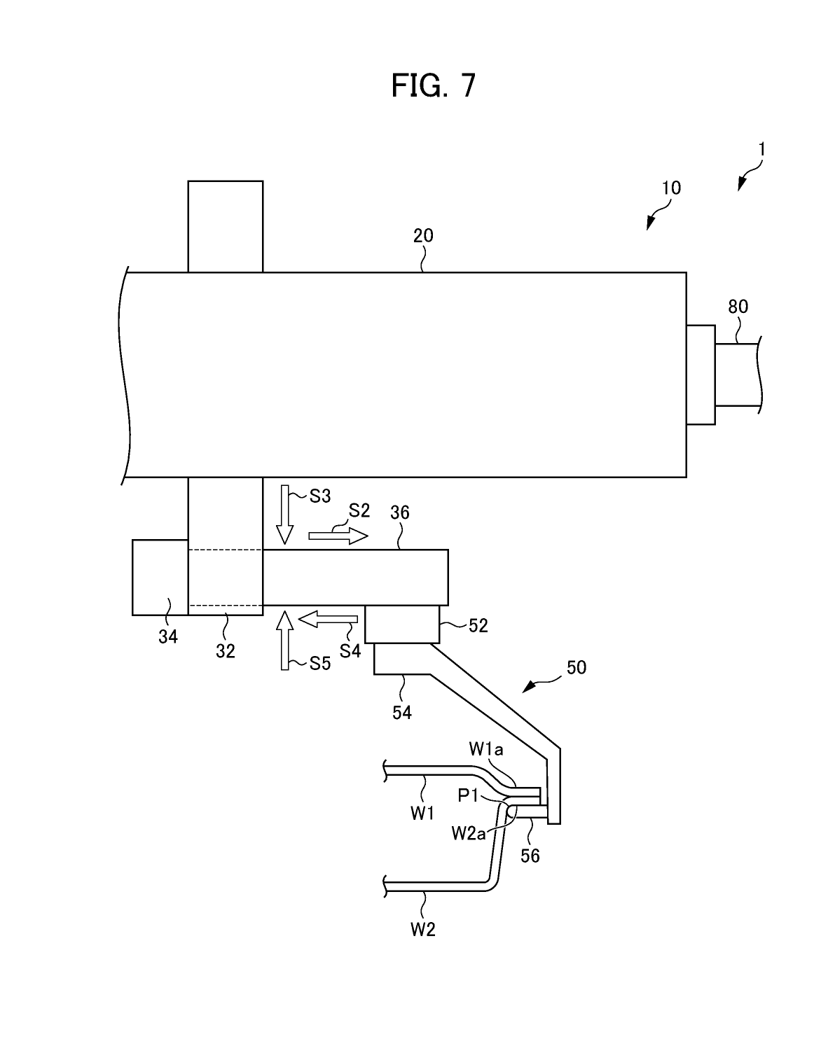

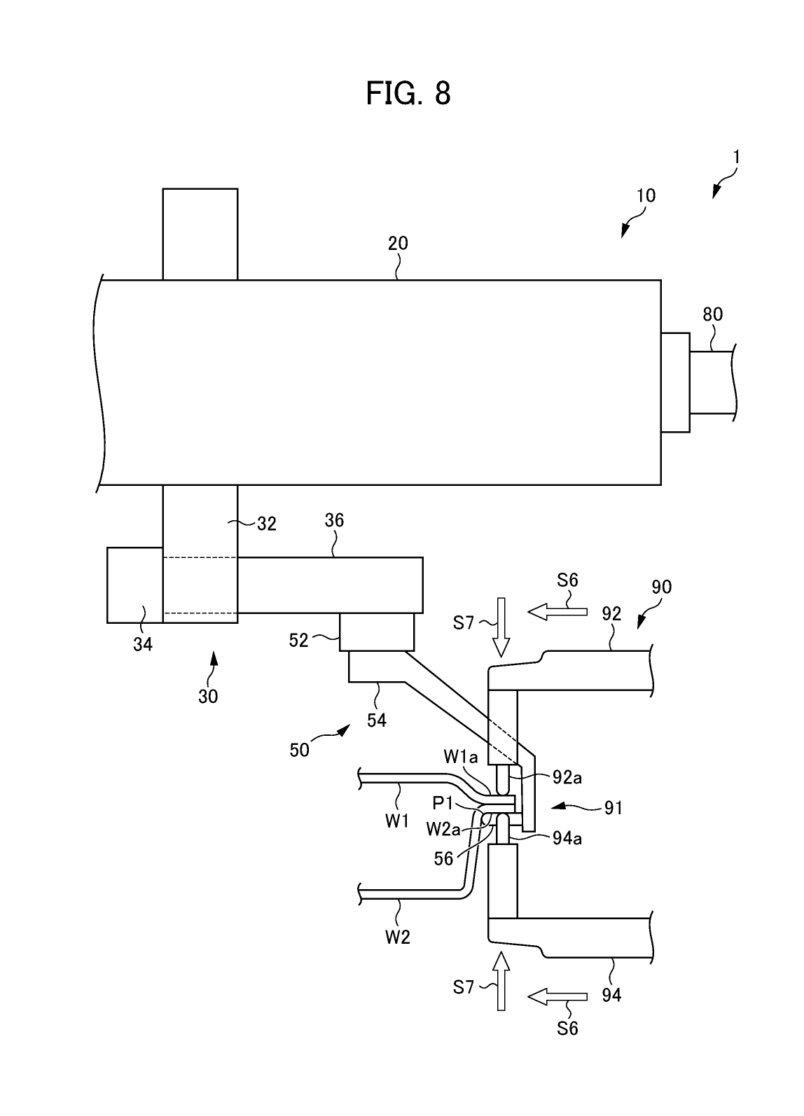

Subsequently, operations of the car body positioning jig device 1 and the welding device 90 (welding gun 91) at a time of a welding operation will be described with reference to FIGS. 6 to 8. FIG. 6 is a plan view describing a state in which a portion of the main body section 10 of the car body positioning jig device is disposed closer to the internal space than the opening at the time of the welding operation. FIG. 7 is a plan view describing a state in which the car body positioning jig device positions the opening of the body assembly at the time of the welding operation. FIG. 8 is a plan view describing a state in which welding is performed by the welding gun in a state in which the car body positioning jig device positions the opening at the time of the welding operation.

First, as illustrated in FIG. 6, the car body positioning jig device 1 moves the main body section 10 from outside the opening K such that at least a portion of the main body section 10 is disposed closer to the internal space N than the opening K. The main body section 10 is moved in an arrow S1 direction by the articulated robot section 80. The main body section 10 is moved from outside the opening K such that at least a portion of the main body section is disposed closer to the internal space N than the opening K. In addition, the first holding part 56 and the second holding part 66 are disposed at positions at which the first holding part 56 and the second holding part 66 do not come into contact with an outer edge (for example, the inner panel W1 or the flanges W1a and W2a) of the opening K by moving in a front direction (arrow S1 direction).

Subsequently, as illustrated in FIG. 7, the car body positioning jig device 1 moves the first holding part 56 and the second holding part 66 to the first region P1 and the second region P2, respectively. The first holding part 56 and the second holding part 66 are moved to the first region P1 and the second region P2 by the first positioning mechanism unit 30 and the second positioning mechanism unit 40, respectively.

Specifically, first, the first front-rear rail 36 (second front-rear rail 46) moves in the rear direction (arrow S2 direction) by a predetermined distance, and then the first right-left rail 32 (second right-left rail 42) moves in the left direction (arrow S3 direction) by a predetermined distance. Then, further, the first right-left rail 32 (second right-left rail 42) moves in the front direction (arrow S4 direction) by a predetermined distance, and the first front-rear rail 36 (second front-rear rail 46) moves in the right direction (arrow S5 direction) by a predetermined distance. Consequently, the first holding part 56 and the second holding part 66 are moved to the first region P1 and the second region P2, respectively.

In addition, consequently, the car body positioning jig device 1 positions the first region P1 and the second region P2 of the opening K in the body assembly W. The car body positioning jig device 1 positions the flanges W1a and W2a formed along the outer edge of the opening K at the first region P1 and the second region P2. In the embodiment, the car body positioning jig device 1 presses and positions the flange W2a on the side of the outer panel W2 to the side of the flange W1a on the side of the inner panel W1.

Subsequently, as illustrated in FIG. 8, the welding device 90 (welding gun 91) welds the opening K (flanges W1a and W2a) positioned at the first region P1 and the second region P2 by the car body positioning jig device 1. Specifically, the welding gun 91 moves in the front direction (arrow S6 direction) in a state in which the electrode chips 92a and 94a are separated to be open from each other. Subsequently, the welding gun 91 moves the gun arms 92 and 94 in the left direction (arrow S7 direction) and causes the electrode chips 92a and 94a to abut the flanges W1a and W2a, respectively. Then, the welding gun 91 welds the opening K (flanges W1a and W2a) in a state of being positioned at the first region P1 and the second region P2 by the car body positioning jig device 1.

According to the embodiment, the following effects are achieved. The car body positioning jig device 1 according to the embodiment includes the first positioning mechanism unit 30, the second positioning mechanism unit 40, and the frame part 20 for supporting the first positioning mechanism unit 30 and the second positioning mechanism unit 40, and thereby at least a portion of the main body section 10 that occupies the largest volume can be disposed closer to the internal space N on the inside than the opening K. Therefore, the main body section 10 can be disposed at a position separated from the movement range of the welding gun 91, and thus it is possible to limit the restriction of the movement of the welding gun 91. In addition, in the car body positioning jig device 1 according to the embodiment, the main body section 10 can be disposed at any position, and the first region P1 and the second region P2 can be set at any positions in the opening K. Consequently, the car body positioning jig device 1 according to the embodiment can further limit the restriction of the movement of the welding device 90, and thus it is possible to come into a state in which the welding operation is easily performed. In addition, in the car body positioning jig device 1 according to the embodiment, the main body section 10 can be disposed at any position, and the first region P1 and the second region P2 can be set at any positions in the opening K. Therefore, the car body positioning jig device can be suitably used for each of different types (car models) of body assemblies.

In addition, in the car body positioning jig device 1 according to the embodiment, the first holding part 56 and the second holding part 66 are disposed at bilaterally symmetrical positions with respect to the frame part 20. Specifically, the first holding part 56 and the second holding part 66 are disposed at bilaterally symmetrical positions with the center line CL as the center in the right-left direction in the rear view (refer to FIG. 4). Consequently, in the configuration, loads applied to the first holding part 56 and the second holding part 66, respectively, are easily balanced. Therefore, in the car body positioning jig device 1 according to the embodiment, it is possible to limit a load that is applied to the articulated robot section 80, and thus it is possible to reduce the articulated robot section 80 in size.

In addition, in the car body positioning jig device 1 according to the embodiment, since the marker 70 is disposed on the upper side of the main body section 10, the measurement of the absolute position of the main body section 10 by the visual sensors 200a and 200b is not hindered by the configurational members of the main body section 10, the articulated robot section 80 itself, or shadows thereof, and thus it is possible to improve accuracy of positional measurement. In addition, consequently, in the car body positioning jig device 1 according to the embodiment, a degree of freedom for disposition of the visual sensors 200a and 200b improves.

In addition, in the car body positioning jig device of the invention, it is preferable that the first positioning mechanism unit include the first right-left direction positioning mechanism unit (for example, the first right-left rail 32 to be described above and the first right-left drive unit) that adjusts the position of the first positioning member in the right-left direction, the second positioning mechanism unit include a second right-left direction positioning mechanism unit (for example, the second right-left rail 42 to be described above and the second right-left drive unit) that adjusts a position of the second positioning member in the right-left direction, and the first right-left direction positioning mechanism unit and the second right-left direction positioning mechanism unit be disposed to be completely accommodated on the more inside of the body assembly than the opening in a side view.

In addition, in the car body positioning jig device 1 according to the embodiment, the first right-left rail 32, the first right-left drive unit, the second right-left rail 42, and the second right-left drive unit are disposed to be completely accommodated on the more inside of the body assembly W than the opening K in a side view. Therefore, the main body section 10 can be disposed at a position further separated from the movement range of the welding gun 91, and thus it is possible to further limit the restriction of the movement of the welding gun 91.

Incidentally, the invention is not limited to the embodiment described above, and the invention also includes a modification, improvement, or the like in a range in which it is possible to achieve the object of the invention. The front and rear, the right and left, and the up and down in the specification are not limited to a traveling direction or a right-left direction of a vehicle, an entering-exiting direction through an opening may be a front-rear direction, for convenience. In the embodiment described above, in the car body positioning jig device 1, the first right-left rail 32, the first up-down rail 34, the first front-rear rail 36, the second right-left rail 42, the second up-down rail 44, and the second front-rear rail 46 are completely disposed closer to the internal space N than the opening K (opening distal end portion KF) in a side view; however, the embodiment is not limited thereto. At least the entirety or a portion of the first right-left rail 32 and the second right-left rail 42 may be disposed closer to the internal space N than the opening K (opening distal end portion KF) in a side view. In the embodiment described above, the first holding part 56 and the second holding part 66 are formed into a bar shape; however, the first holding part 56 and the second holding part 66 may be formed into a clamper shape so as to pinch and support a panel.

### EXPLANATION OF REFERENCE NUMERALS

1 CAR BODY POSITIONING JIG DEVICE
10 MAIN BODY SECTION
20 FRAME PART
30 FIRST POSITIONING MECHANISM UNIT
32 FIRST RIGHT-LEFT RAIL
34 FIRST UP-DOWN RAIL
36 FIRST FRONT-REAR RAIL
40 SECOND POSITIONING MECHANISM UNIT
42 SECOND RIGHT-LEFT RAIL
44 SECOND UP-DOWN RAIL
46 SECOND FRONT-REAR RAIL
50 FIRST POSITIONING MEMBER
52 FIRST PROXIMAL END PORTION
54 FIRST ARM PART
56 FIRST HOLDING PART
60 SECOND POSITIONING MEMBER
62 SECOND PROXIMAL END PORTION
64 SECOND ARM PART
66 SECOND HOLDING PART
70 MARKER
80 ARTICULATED ROBOT SECTION
90 WELDING DEVICE
91 WELDING GUN
K OPENING
N INTERNAL SPACE
P1 FIRST REGION
P2 SECOND REGION
W BODY ASSEMBLY

1. A car body positioning jig device comprising:
a first positioning member that positions a first region of an opening in a body assembly;
a second positioning member that positions a second region of the opening in the body assembly;
a main body section; and
an articulated robot section by which the main body section is movably supported and which is capable of disposing at least a portion of the main body section closer to an inside of the body assembly than the opening,
wherein the main body section includes
a first positioning mechanism unit for adjustably supporting a position of the first positioning member,
a second positioning mechanism unit for adjustably supporting a position of the second positioning member, and
a frame part for supporting the first positioning mechanism unit and the second positioning mechanism unit,
wherein the first positioning member includes
a first arm part that is attached to the first positioning mechanism unit and is disposed to be extended to an outer edge side of the opening, and
a first holding part that is disposed on a distal end side of the first arm part and positions the first region in the opening, and
wherein the second positioning member includes
a second arm part that is attached to the second positioning mechanism unit and is disposed to be extended to an outer edge side of the opening, and
a second holding part that is disposed on a distal end side of the second arm part and positions the second region in the opening.

2. The car body positioning jig device according to claim 1, wherein the first holding part and the second holding part are disposed at positions on both right and left sides with respect to the frame part.

3. The car body positioning jig device according to claim 1, wherein the car body positioning jig device corrects a position by a visual sensor, and
wherein a marker for the visual sensor is attached to an upper side of the frame part.

4. The car body positioning jig device according to claim 1, wherein the first positioning mechanism unit includes a first right-left direction positioning mechanism unit that adjusts a position of the first positioning member in a right-left direction,
wherein the second positioning mechanism unit includes a second right-left direction positioning mechanism unit that adjusts a position of the second positioning member in the right-left direction, and
wherein the first right-left direction positioning mechanism unit and the second right-left direction positioning mechanism unit are disposed to be completely accommodated on the more inside of the body assembly than the opening in a side view.

5. The car body positioning jig device according to claim 2, wherein the car body positioning jig device corrects a position by a visual sensor, and
wherein a marker for the visual sensor is attached to an upper side of the frame part.

6. The car body positioning jig device according to claim 2, wherein the first positioning mechanism unit includes a first right-left direction positioning mechanism unit that adjusts a position of the first positioning member in a right-left direction,
wherein the second positioning mechanism unit includes a second right-left direction positioning mechanism unit that adjusts a position of the second positioning member in the right-left direction, and
wherein the first right-left direction positioning mechanism unit and the second right-left direction positioning mechanism unit are disposed to be completely accommodated on the more inside of the body assembly than the opening in a side view.

7. The car body positioning jig device according to claim 3, wherein the first positioning mechanism unit includes a first right-left direction positioning mechanism unit that adjusts a position of the first positioning member in a right-left direction,
wherein the second positioning mechanism unit includes a second right-left direction positioning mechanism unit that adjusts a position of the second positioning member in the right-left direction, and
wherein the first right-left direction positioning mechanism unit and the second right-left direction positioning mechanism unit are disposed to be completely accommodated on the more inside of the body assembly than the opening in a side view.

8. The car body positioning jig device according to claim 5, wherein the first positioning mechanism unit includes a first right-left direction positioning mechanism unit that adjusts a position of the first positioning member in a right-left direction,
wherein the second positioning mechanism unit includes a second right-left direction positioning mechanism unit that adjusts a position of the second positioning member in the right-left direction, and
wherein the first right-left direction positioning mechanism unit and the second right-left direction positioning mechanism unit are disposed to be completely accommodated on the more inside of the body assembly than the opening in a side view.
